(19) United States
(12) Patent Application Publication
(10) Pub. No.: US 2026/0352736 A1
(43) Pub. Date: Nov. 5, 2026

(54) INDICATING EXTENDED REALITY (XR) AWARENESS AND XR TRAFFIC CHARACTERISTICS

(71) Applicant: Google LLC, Mountain View, CA (US)

(72) Inventors: Abdellatif Salah, Cambridge (GB); Chih-Hsiang Wu, Taipei (TW)

(21) Appl. No.: 19/101,789

(22) PCT Filed: Aug. 4, 2023
(86) PCT No.: PCT/US2023/029570

§ 371 Date: Feb. 6, 2025

Related U.S. Application Data
(60) Provisional application No. 63/370,832, filed on Aug. 9, 2022.
(60) Provisional application No. 63/411,611, filed on Sep. 29, 2022.

(51) Int. Cl. H04L 67/131; H04L 67/141; H04N 21/2662; H04W 28/02

(52) U.S. Cl. CPC H04L 67/131; H04L 67/141; H04W 28/0268; H04N 21/2662

(57) ABSTRACT

This disclosure provides methods and systems for wireless communications having traffic characteristics. A network entity (112) receives (324) from a core network (150), an indication of parameters of a protocol data unit (PDU) session established between the network entity and a data network (160/170). The parameters may be specific to the traffic characteristics. The parameters are in a converted format converted from an original format. The original format of the parameters is used for traffic in between the data network and the core network. The network entity updates one or more wireless signaling configurations based on the parameters. The network entity communicates with a device using the updated one or more configurations. In some cases, the one or more configurations include scheduling configurations for traffic flows to be scheduled via one or more of: configured uplink grants, semi-persistent uplink or downlink grants, and dynamic uplink or downlink grants.

### CROSS-REFERENCE TO RELATED APPLICATION

This application claims, in accordance with Article 8 of the Patent Cooperation Treaty (PCT), the priority and benefits to the U.S. Provisional Application No. 63/370,832, entitled “INDICATING EXTENDED REALITY (XR) AWARENESS AND XR TRAFFIC CHARACTERISTICS,” filed Aug. 9, 2022, and the U.S. Provisional Application No. 63/411,611, entitled “INDICATING EXTENDED REALITY (XR) AWARENESS AND XR TRAFFIC CHARACTERISTICS,” filed Sep. 29, 2022, which are expressly incorporated by reference herein in its entirety.

### TECHNICAL FIELD

The present disclosure relates generally to wireless communication, and more particularly, to systems and methods of extended reality (XR) awareness and indicating XR traffic characteristics.

### BACKGROUND

The Third Generation Partnership Project (3GPP) is currently in the process of specifying a new Radio Interface called 5G New Radio (5G NR) as well as a Next Generation Packet Core Network (NG-CN or NGC). The 5G NR architecture will have three components: a 5G Radio Access Network (5G-RAN), a 5G Core Network (5GC), and a User Equipment (UE). In order to facilitate the enablement of different data services and requirements, the 3GPP 5G NR cellular network supports network slicing, which enables the multiplexing of virtualized and independent logical networks on the same physical network infrastructure.

Extended reality (XR) includes various augmented reality, virtual reality, and mixed reality applications that take advantages of 5G NR network advanced capabilities (e.g., low latency, high reliability, and high data transfer rate, etc.). The XR services are characterized by stringent requirements for periodicity, multiple flows, jitter avoidance, low latency, high reliability, among others. As opposed to video streaming, XR applications are real-time (or near real-time) and expected to respond quickly to the user movement and its commands and controls. The XR video frames are expected to be delivered as soon as they are encoded by the codec, hence the XR traffic may suffer from jitter due to the variations in delay when video frames are encoded. The XR packet size is also variable. Therefore, XR traffic poses a specific set of challenges to be delivered through the 5G NR network in view of the XR traffic characteristics.

### SUMMARY

The present disclosure provides methods and techniques for enabling communications between a core network and a radio access network (RAN) with traffic characteristics tailored to an application of an application server, such as extended reality (XR), so that the RAN may update configurations with user equipment (UE) devices according to awareness of the application. The disclosed methods and techniques may apply to the 5^{th} generation (5G) new radio (NR) network systems and beyond (e.g., 6G). For illustrative purposes, 5G systems are used as example embodiments herein. At a high level, the present disclosure provides various techniques to convert traffic parameters (e.g., non-radio or general packet radio service (GPRS) tunneling protocol (GTP) parameters), from application servers to the core network, into radio signaling parameters from the RAN to UE devices in order to indicate application characteristics without causing negative impact, if not substantially improving on, data transfer rate, latency, or other aspects (e.g., by supporting improved settings at the RAN and the UE devices).

For example, the present disclosure provides methods and techniques for converting (e.g., mapping, deriving, computing, etc.) an original format of non-radio traffic (e.g., of a video application related to cloud gaming, XR, etc.), at a core network, into a new format indicating radio traffic properties (e.g., congestion, fading, mobility/handover, channel quality). The new format may reuse existing fields of or add new fields into, for example, time sensitive communication assistance information (TSCAI) and/or new generation application protocol (NGAP) (e.g., control plane signaling between gNB and AMF) to support XR and similar applications.

XR may include augmented reality (AR), virtual reality (VR), and mixed reality (MR). VR immerses users in a virtual environment substituting perceptions of actual surroundings (e.g., the wearer of VR gears is not expected to sense the actual surroundings). AR provides a computer-generated overlay to the actual surroundings with clear indication of the virtual overlay (e.g., floating graphics, markers, numbers, or texts on top of objects in the actual surroundings). MR provides a realistic artificial overlay (e.g., computer-generated items as part of the actual surrounding perception). As such, XR requires instant and large quantities of data exchanging between UE devices and XR service providers.

These XR services are characterized by stringent requirements for periodicity, multiple flows, jitter avoidance, low latency, high reliability, high data rates, among others. For example, cloud gaming often uses remote servers to execute gaming applications, thus requiring instant (e.g., real time or near real time) streaming of visual contents, user controls, and feedback to the user. XR traffic may be quasi-periodic with period equal to the inverse to the frame rate. Due to high frame rate requirements for XR applications, the XR traffic may suffer from jitter due to the variations in delay when video frames are encoded. The XR packet size is also variable. Therefore, XR traffic poses a specific set of challenges in view of the XR traffic characteristics.

Aspects of the present disclosure address the above-noted and other deficiencies by enabling mutual awareness of characteristics of the application traffic at both the transmission node and the reception node. For example, mutual awareness between the application functions at the 5G core and the RAN allows for optimization of the end-to-end system to better support XR applications. On the application side, awareness by the application of 5G RAN radio parameters helps the application quickly adjust and adapt to the RAN network conditions (e.g., congestion, handover, interference, beam blockage, etc.). As a result, the RAN may proactively address potential degradation/variation of network conditions by, for example, adapting the codec rate of video encoding to achieve desired quality of experience (QoE) as well as to ensure good system capacity. Conversely, awareness by the RAN of XR traffic characteristics (e.g., non-radio, IP packet characteristics) helps the RAN better schedule XR traffic.

According to aspects of the present disclosure, for example, a network entity, such as a 5G RAN, receives from a core network, an indication of parameters of a protocol data unit (PDU) session established between the network entity and a data network. The parameters of the PDU session may be specific to traffic of immersive experiences (e.g., XR). The parameters are in a converted format converted from an original format. The data network and the core network use the original format of the parameters to communicate traffic between each another.

The network entity updates one or more wireless signaling configurations based on the parameters of the PDU session (e.g., updating scheduling configurations with the UE device). The network entity communicates with a UE device using the updated one or more configurations. In some cases, the one or more configurations include scheduling configurations for periodic and deterministic traffic flows to be scheduled via one or more of: configured uplink grants, semi-persistent uplink or downlink grants, and dynamic uplink or downlink grants.

According to aspects of the present disclosure and complementary to the above, a core network receives, from a data network, application layer traffic in an original format. The core network converts the traffic from the original format to a converted format. The core network transmits, to a RAN, the indication of the parameters in the converted format. The indication belongs to a PDU session established between the RAN and the data network. The indicated parameters of the PDU session include the traffic of the immersive experience.

The network entity may receive the indication from one or more network functions of the core network. The one or more network functions may include an application function (AF). The AF may support an XR application. For example, the data network may be an XR server or a network entity that provides a data stream encoded by a video codec to the core network. The original format between the data network and the core network may conform to session description protocol (SDP).

The network entity may receive parameters indicating various aspects of XR traffic and thus be aware of XR applications. For example, the parameters include one or a combination of two or more of: a periodicity of a PDU set; a periodicity of a video frame or slice; a start time of a first PDU set, a first video frame, or a first video slice; an identifier (ID) of the first PDU set, the first video frame, or the first video slice; information about relationship of PDUs within the PDU set, the video frame, or the video slice; an indication of a last PDU in the PDU set; a priority associated with the PDU set, the video frame, or the video slice; a delay budget associated with the PDU set, the video frame, or the video slice; a size of the PDU set, the video frame, or the video slice; and jitter statistics of the traffic.

In some cases, the converted format includes one or more fields and values directly mapped from fields and values of the original format. In some cases, the converted format includes one or more fields and values derived (e.g., calculated, transformed, or otherwise computed) from the fields and values of the original format. The converted format may include time sensitive communication (TSC) assistance information (TSCAI) of a TSC service. The traffic may be characterized by characteristics carried with attributes of the TSCAI. The TSCAI may include one or a combination of two or more of the following fields: traffic type; XR traffic flow; encryption keys; group of pictures (GoP) information; synchronization information; and configuration granularity.

According to aspects of the present disclosure, the original format between the data network and the core network includes session description protocol (SDP) and the attributes of the TSCAI are in a mapping relationship to attributes of the SDP. For example, the mapping relationship includes (1) one-to-one, (2) multiple-to-one, and (3) one-to-multiple mapping between the attributes of the SDP and the attributes of the TSCAI.

The data traffic may be configured based on a type of video frames or a type of video slices, wherein the type of video frames includes at least one of: I-frame, P-frame, or B-frame, and wherein the type of video slices includes at least one of I-slice, P-slice, or B-slice. Examples relate to I-frame or P-frame are briefly discussed in relation to FIG. 10.

According to aspects of the present disclosure, the converted format conforms to new generation application protocol (NGAP). The indication of the PDU session includes at least one of: a message of a PDU session resource setup request; or a message of a PDU session resource modification request. In some cases, the indication of the PDU session includes an information element (IE) of the message of the PDU session resource setup request or the message of the PDU session resource modification request. The IE may indicate one or a combination of two or more of: traffic periodicity; a packet time; a maximum packet time; a burst arrival time; a bandwidth; jitter statistics; an encryption key; a frame duration; a priority of video frame or slice; a number of PDUs in a PDU set; and statistics of PDU set sizes. The statistics of PDU set sizes may include at least values of: a median, a mean, a standard deviation, a maximum, and a minimum, measured in bits, bytes, or kilobytes.

The IE may further or alternatively indicate one or a combination of two or more of: statistics of video frame or slice such as one or more values of: a median, a mean, a standard deviation, a maximum, and a minimum, measured in bits, bytes, or kilobytes; a delay budget including one or more of budgets: per application, per traffic flow, per type of video frame, per type of video slice, or per PDU set; group of pictures (GoP) information including at least one of: size of a GoP, a start time of the GoP, a time offset of the GoP, or a type of video frames/slices in the GoP; and synchronization information. The synchronization information may include one or more of: synchronization requirements per flow, dependency between traffic flows, a positive or negative time offset with respect to a master clock, a positive or negative time offset with respect to a specific flow, and a request to adjust the timing; and a priority of a PDU set.

Details of XP awareness configurations, PDU sets, NGAP IE or group, and various aspects of the present disclosure are discussed in detail below.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for indicating traffic characteristics between a core network 150 and a radio access network (RAN) 112, according to some embodiments;

FIG. 2 is an example diagram depicting application awareness of traffic characteristics among user equipment (UE) devices 105, the RAN 112, the core network 150, and the application server 160/170, according to some embodiments;

FIG. 3 is a signaling diagram depicting an example method of indicating traffic characteristics and updating configurations based on the traffic characteristics, according to some embodiments;

FIG. 4 illustrates an example end-to-end application and RAN awareness between the UE devices 105 and the application server 160/170, according to some embodiments;

FIG. 5 is a flow diagram depicting a method of wireless communications indicating traffic characteristics by a network entity, according to some embodiments;

FIG. 6 is a flow diagram depicting a method of wireless communications by a core network, according to some embodiments; and

FIG. 7 illustrates an example table mapping information from an application server to information (e.g., configuration) between RAN and UE devices, according to some embodiments.

FIG. 8 illustrates an example table of information elements in a protocol data unit (PDU) session resource setup request, according to some embodiments.

FIG. 9 illustrates an example table of information elements of traffic characteristics, according to some embodiments.

FIG. 10 illustrates an example of video frames fragmentations and data packetization for a PDU set, according to some embodiments.

### DETAILED DESCRIPTION

For ease of illustration, the following techniques are described in an example context in which one or more UE devices and RANs implement one or more radio access technologies (RATs) including at least a Fifth Generation (5G) New Radio (NR) standard (e.g., Third Generation Partnership Project (3GPP) Release 15, 3GPP Release 16, etc.) (hereinafter, “5G NR” or “5G NR standard”). However, the present disclosure is not limited to networks employing a 5G NR RAT configuration, but rather the techniques described herein can be applied to any combination of different RATs employed at the UE devices and the RANs. Also, the present disclosure is not limited to the examples and context described herein, but rather the techniques described herein can be applied to any network environment.

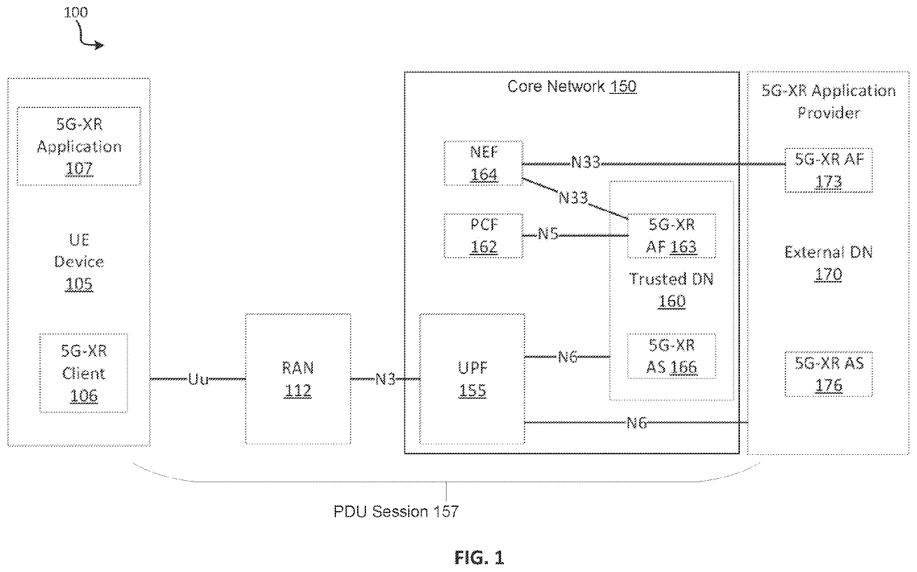

FIG. 1 is a block diagram depicting an example environment 100 for indicating traffic characteristics between a core network 150 and a radio access network (RAN) 112, according to some embodiments. The communications between the core network 150 and the RAN 112 may include indications that describe traffic characteristics specific to applications of the data network (DN), which may be a trusted DN 160 or an external DN 170 (e.g., wired DNs). For example, the indications may include parameters of a protocol data unit (PDU) session 157 established between the RAN 112 and the DN 160 or 170. The parameters used for traffic in between the DN 160/170 and the core network 150 may be in a first, original format. The core network 150 may convert the parameters from the original format into a second, converted format and provides the RAN 112 the parameters in the converted format. The RAN 112 may use the parameters to update relevant configurations of wireless communications with the user equipment (UE) device 105 based on the traffic characteristics.

The traffic-characteristics specific configurations may be referred to traffic awareness or “awareness” in the discussions below. For example, the parameters may include attributes of Time Sensitive Communication Assistance Information (TSCAI) to signal traffic characteristics from the DN 160/170 to the RAN 112. In some embodiments, the parameters may include information elements in new generation application protocol (NGAP) messages to signal the traffic characteristics. The RAN 112 may update or adjust settings, such as connected mode discontinuous reception (C-DRX), semi-persistent scheduling (SPS), or cloud gaming, based on the traffic characteristics.

As shown in FIG. 1, the example environment 100 illustrates an example system architecture of a 5G system capable of delivering data for extended reality (XR) applications (e.g., XR traffic). In FIG. 1, relevant functions of the 5G system are illustrated, including the UE device 105, the RAN 112, and the core network (CN) 150. The CN 150 includes the user plane function (UPF) 155, the trusted data network (DN) 160, the policy control function (PCF) 162, and the network exposure function (NEF) 164. XR specific functions or components may include the 5G-XR client 106 of the UE device 105, the application function (AF) 163 and the application server (AS) 166 in the trusted DN 160, as well as the AF 173 and AS 176 in the external DN 170, which provides various XR applications. The external DN 170 may be a 5G-XR application provider leveraging 5G system functionalities (e.g., coupled with the NEF 164 and UPF 155 of the 5G system). The UE device 105 including a 5G-XR aware application 107 may make use of the 5G-XR client 106 and network functions, using network interfaces and APIs.

XR may refer to human-machine interaction experiences with visual, audio, and/or haptic computer-generated object enhancement or replacement. For example, XR may be one or more of augmented reality (AR), mixed reality (MR), virtual reality (VR), and interpolations among these XR variations. AR refers to providing a user with additional information or artificial generated items or content overlaid upon the real surroundings. VR refers to a rendered version (e.g., generated by computers) of a visual/audio scene. MR refers to an advanced form of AR where some virtual elements are inserted into the physical scene with the intent to provide the illusion that the elements are part of the real scene. In some cases, AR, MR, and VR may generally be referred to as immersion, which often requires measurements of motions of the user (e.g., six degrees of freedom) and providing near-instant feedback (e.g., via visual, audio, and tactile components) to the user.

Computer technologies (e.g., 3D graphics and measurements) and wearable technologies (e.g., motion sensors, visual and audio feedback, etc.) are enablers of XR. For example, human-to-machine and human-to-human communications take advantages of handheld and wearable end user devices (e.g., UE devices). These technologies capture, generate, process, and communicate with a large amount of data, often in real time (or with stringent low latency requirement). As shown in FIG. 1, the 5G-XR application 107 and the 5G-XR client 106 of the UE device 105 may capture and communicate user data with the RAN 112. The XR application 107 may acquire and process data (e.g., via camera, motion sensors, microphones, etc.) of the users for uploading to the DN 160/170 via the RAN 112 and the core network 150. The XR client 106 may process data received and process data from the DN 160/170. For example, the XR client 106 may include a modem for receiving and/or transmitting XR traffic. In some cases, the XR application 107 and the XR client 106 may be the same or implemented in the same device, e.g., a modem and a VR display on the same headset. For non-standalone XR devices, separate devices may perform the functions of the XR application 107 and the XR client 106, such as a VR headset tethered to a mobile phone.

Cloud gaming is an example use case of XR, because cloud gaming may take advantage of AR, MR, or VR. cloud gaming applications often offload a large amount of computations from various UE devices (e.g., VR headsets, cameras, motion sensors, smart phones, etc.) to edge or remote server(s). cloud gaming and other XR use cases are often characterized by quasi-periodic traffic (with possible jitter) and high downlink (DL) data rates (e.g., video steam) combined with frequent uplink (UL) signaling, (e.g., pose/control update and/or UL video stream). In order to achieve cognitive presence and perceptive presence, both DL and UL traffic may be characterized by relatively strict packet delay budget (PDB) or threshold criteria. However, the current discontinuous reception (DRX) configurations do not fit well for (i) non-integer XR traffic periodicity, (ii) variable XR data rate, and/or (iii) quasi-periodic XR periodicity. The present disclosure provides methods and techniques for satisfying these XR-driven requirements.

The set of anticipated XR and cloud gaming services exhibits a certain variety and set of characteristics for the data streams (e.g., video) and they may change “on-the-fly” or dynamically. Additional information on the running services from higher layers, e.g., the QoS flow association, frame-level QoS, PDU Set based QoS, XR specific QoS, etc., may be beneficial to facilitate informed choices of radio parameters by the RAN 112. XR application awareness by UE devices and network entities may improve the user experience, improve the NR system capacity in supporting XR services, and reduce the UE power consumption (e.g., effective radio parameters increase energy efficiency and may improve battery life in many small-scale UE devices).

In current practices, XR interfaces often require wired connections supported by high-speed data transfer rates. For example, VR headsets are often wired to computer systems having high processing capacities. The computer systems may connect to XR applications (e.g., servers) via a digital subscriber line (DSL) or an optical fiber line that provides access to the internet at high speeds. However, current wireless communication standards may be limited for XR content by comparison to wired communications. For example, XR traffics are often quasi-periodic with periodicity being the inverse of the XR frame rate. When high frame rates are required (e.g., often above 60-120 frames per second), the XR traffic may suffer from jitter due to the delay variations at the codec to encode the video frames. The jitter has been statistically modeled in 3GPP as truncated Gaussian distribution with a 2 milliseconds (ms) standard deviation and a ±4 ms range (while the expectation for XR applications is 1 ms). In another example, the XR packet size may be variable due to the variability in the video frame content and has also been statistically modeled in 3GPP as truncated Gaussian distribution, limiting XR experiences.

Yet the wireless XR or cloud gaming interfaces can offer improved user experiences, such as movement freedom and removal of location or behavioral restrictions (e.g., not confined in certain rooms or facilities, and allowing for running, dancing, or other behaviors that may otherwise be limited by wired connections). Furthermore, wireless XR services may also offer XR applications in areas where DSL or fiberoptics networks are not available. The present disclosure provides methods and techniques for improving wireless communications between the data network and the UE devices by tailoring network traffic between the core network and the RAN to traffic characteristics (e.g., by converting formats to better represent the traffic characteristics).

For example, the awareness of the traffic characteristics may enable the RAN and the core network to improve wireless communications in various scenarios. One scenario includes offline sharing of 3D objects may include sharing 3D models or objects, and 3D MR scenes amongst users, such as by using a smartphone equipped with a depth camera to capture and share a 3D object.

Another scenario includes XR conferencing, which allows people interacting in a virtual environment and presenting 3D objects within the virtual environment (e.g., as opposed to presentations in documents or on screens).

Traffic awareness according to the present disclosure may improve support for these XR applications. For example, mutual awareness between the application server and RAN helps to optimize the end-to-end (E2E) system to better support XR applications. The traffic awareness (e.g., for the XR traffic) may include awareness at both the application side and the RAN side.

On the application side, awareness about the RAN means that the application may quickly adjust and adapt to the RAN network conditions (congestion, handover, interference, beam blockage, etc.) or to be proactive about the potential degradation and variation of network conditions. The application may adapt the codec rates to help provide the desired quality of experience (QoE) and guarantee good system capacity.

On the RAN side, RAN awareness of the application may help better schedule the application-specific traffic (e.g., XR traffic). Awareness of traffic characteristics (e.g., frame periodicity, jitter, burst sizes, frame importance, frames correlation, etc.) helps the RAN to carry better scheduling (e.g., by adjusting the SPS/C-DRX configurations), and carry better prioritization and dropping (e.g., dropping PDUs belonging to a PDU set with less importance, or dropping the PDU set if some of its PDUs are lost). Detailed examples are further discussed below.

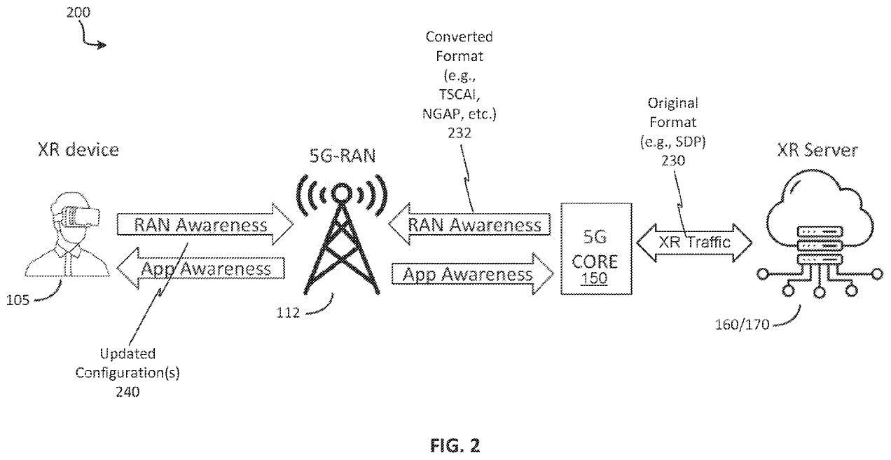

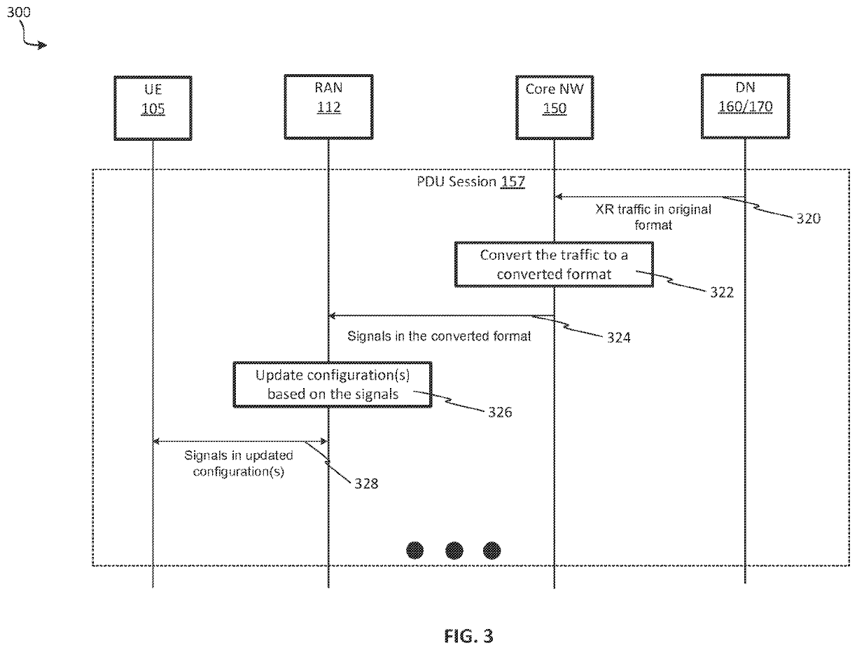

The core network 150 can convert an original format from the DN 160/170 based on traffic characteristics and provide the transmissions in the converted format to the RAN 112. The RAN 112 may update scheduling configurations with the UE device 105 based on the traffic characteristics. For example, FIG. 2 demonstrates traffic awareness among the network entities, while FIG. 3 demonstrates a call flow diagram of the format conversions and traffic awareness configurations.

FIG. 2 is an example diagram 200 depicting application awareness of traffic characteristics among user equipment (UE) devices 105, the RAN 112, the core network 150, and the application server 160/170, according to some embodiments. As shown, the XR server 160/170 may communicate XR traffic in an original format 230 (e.g., SDP or other non-radio parameters) with the 5G core network 150. The 5G core network 150 converts the XR traffic in the original format 230 into the converted format 232 to enable the RAN 112 to be aware of the XR traffic. For example, the converted format 232 characterizes video related properties of the XR traffic. The RAN 112 may then update configurations 240 with the UE device 105 for transmitting signals in view of the XR traffic (e.g., application awareness). In response, the UE device 105 may transmit signals to the RAN 112 in view of the XR traffic.

FIG. 3 is a signaling diagram 300 depicting an example method of indicating traffic characteristics and updating configurations based on the traffic characteristics, according to some embodiments. In the PDU session 157 established between the RAN 112 and the DN 160/170, the core network 150 receives 320 traffic in an original format. The traffic includes XR traffic and other traffic of immersive experiences from an XR service of the DN 160/170. For example, the XR traffic may be from the XR AF 163/173 or the XR AS 166/176 of FIG. 1. In an example, the DN 160/170 may include an XR server or otherwise to provide, to the core network, a data stream encoded by a video codec.

As mentioned above, the XR traffic characteristics can be classified into static (to be signaled out-of-band) and dynamic (to be signaled in band). For example, the XR traffic periodicity requires an out-of-band signaling as it is not changing very frequently. However, the marking of PDUs in a PDU set requires in-band signaling as it is more dynamic. Hence, the two categories of traffic characteristics may need two different mechanisms for the signaling from the XR server or the video codec to the 5G-RAN. For the dynamic signaling, the real-time transport protocol (RTP) header can be used to signal the dynamic traffic characteristics.

In order to signal the static XR traffic characteristics (e.g., non-radio, IP packet characteristics) from the XR server or the video codec to the RAN 112, the core network 150 receives 320 the XR traffic in the original format from an XR server of the DN 160/170, converts 322 the traffic to a converted format, and transmits 324 the signals in the converted format to the RAN 112. The original format between the DN 160/170 and the core network 150 may include session description protocol (SDP). The converted format between the core network 150 and the RAN 112 may include time sensitive communication (TSC) or new generation application protocol (NGAP). The core network 150 may then convert the XR traffic characteristics (e.g., non-radio, IP packet characteristics) from SDP to TSC or from SDP to NGAP.

The conversion may include mapping or derivation from values in one or more fields in the original format to values in one or more fields in the converted format. For example, the core network 150 may perform the conversion in tow methods. In a first method, the core network 150 maps a field in the original format to another field in the converted format, e.g., by mapping SDP frame-rate subfield to the TSCAI periodicity field. In a second method, the core network 150 may derive values in the converted format (e.g., a TSCAI periodicity) from values in the original format (e.g., SDP framerate). The derivation may be a calculation or a transformation, such as, for example, from an index to a value in milliseconds or vice versa.

The converted format may allow the RAN 112 to be aware of various characteristics of the XR traffic. For example, the awareness may include: a) PDU set, video frame/slice periodicity, or video frame rate (e.g., 60, 90 or 120 frames per second), b) a start time of the first PDU set or video frame/slice, c) an identity of a PDU set or video frame/slice, d) relationship information amongst PDUs within the same PDU set or video frame/slice, e) PDU set end indication or indication of the last PDU in a PDU set, f) PDU set or video frame/slice priority and/or delay budget, g) PDU set or video frame/slice size and/or number of PDUs in a PDU set, and h) Jitter statistics such as, mean, standard deviation and the range of the jitter (minimum and maximum value). These characteristics may each be useful for updating configurations at the RAN 112 and the UE device 105.

As shown in FIG. 3, the RAN 112 may update 326 configuration(s) based on the received signals in the converted format, to enable the UE device 105 to be aware of the traffic characteristics. The configurations may include scheduling configurations for periodic and deterministic traffic flows to be scheduled via one or more of: configured grants, semi-persistent grants, and dynamic grants. For example, based on the traffic characteristics, the RAN 112 may update configurations in: a) a periodicity of SPS or configured grant, or a C-DRX cycle length, based on the PDU set or video frame/slice periodicity, b) an offset based on the start time of the first PDU set or video frame/slice, c) prioritizing a PDU in a PDU set or a video frame/slice based on the identity of the PDU set or the video frame/slice, d) dropping or prioritizing a PDU based on the relationship information amongst PDUs, e) separation between PDU sets based on the indication of a last PDU in a set, f) prioritizing a PDU from a PDU set or video frame/slice based on the delay budget, g) a C-DRX inactivity timer or SPS/cloud gaming resource allocation based on the number of PDUs in a PDU set, and h) a C-DRX duration based on the jitter statistics. The RAN 112 transmits the updated configurations to the UE device 105. The RAN 112 and the UE device 105 may then signal 328 with each other in the updated configurations.

When the core network 150 converts the original format into the converted format, the original format and the converted format may be selected from various formats. In one example, the converted format is in TSC assistance information (TSCAI) having parameters configured according to information from time sensitive networking (TSN) application function (AF). TSN allows Ethernet networks to offer quality of service (QOS) Guarantees and deterministic connectivity. Both 5G ultra reliable low latency communications (URLLC) and TSN may enable applications with low latency and high reliability requirements. The TSCAI parameters may therefore take advantage of the low latency characteristics for XR traffic. The awareness of TSN traffic pattern may enable the RAN 112 to efficiently schedule periodic, quasi-periodic (e.g., with jitter), and deterministic traffic flows, for example, either via configured grants, semi-persistent scheduling, or dynamic grants. For example, the TSC traffic characteristics may include a flow direction (e.g., uplink or downlink), a periodicity (e.g., the time period between the start of two bursts), a burst arrival time (e.g., the latest possible time when the first packet of the data burst arrives at either the ingress of the RAN or egress interface of the UE), and a survival time (e.g., a time period an application may survive without any data burst).

In another example, the converted format is in NGAP, which allows the control plane plane to signal between the RAN 112 and the Access and Mobility Function (AMF) of the core network 150.

In some implementations, the RAN 112 includes a central unit (CU) and a distributed unit (DU). The CU receives the converted format from the AMF in NGAP or TSCAI. In one implantation, the CU transmits the parameters in the converted format to the DU, e.g., in a F1 application protocol (F1AP). For example, the CU can transmit a first F1AP message including the parameters to the DU. In another implantation, the CU transmits the parameters in the converted format to the DU in TSCAI. In response, the DU updates the configurations as described above and transmits a second F1AP message includes the updated configurations to the CU. The CU generates a RRC message including the updated configurations and transmits a third F1AP message including the RRC message to the DU. In one example, the RRC message is an “RRCReconfiguration” message. The DU then transmits the RRC message to the UE device 105. In one example, the first F1AP message is a “UE Context Setup Request” or “UE Context Modification Request” message. In one example, the second F1AP message is a “UE Context Setup Response”, “UE Context Modification Response” or a “UE Context Modification Required” message. In one example, the third F1AP message is a “DL RRC Message Transfer” message.

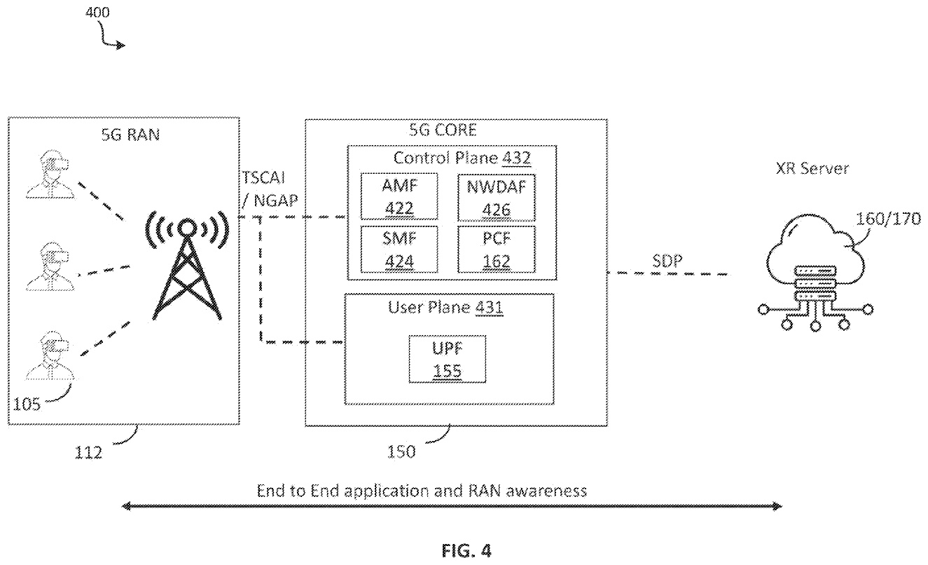

FIG. 4 illustrates an example 400 of end-to-end application and RAN awareness between the UE devices 105 and the application server 160/170, according to some embodiments. In particular, FIG. 4 illustrates the traffic characteristic specific communications for the user plane 431 and the control plane 432 in the core network 150. As shown, the RAN 112 may communicate with multiple UE devices 105. For example, the UE devices 105 may include VR headsets, AR glasses, smartphones, and/or wearables devices equipped with a modem or tethered to a device equipped with a modem. The RAN 112 and the core network 150 communicates in the converted format (e.g., TSCAI or NGAP) on either or both the control plane 432 and the user plane 431. The control plane 432 as illustrated may include the AMF 422, the session management function (SMF) 424, the network data analytics function (NWDAF) 426, and the PCF 162, as well as other functions not illustrated.

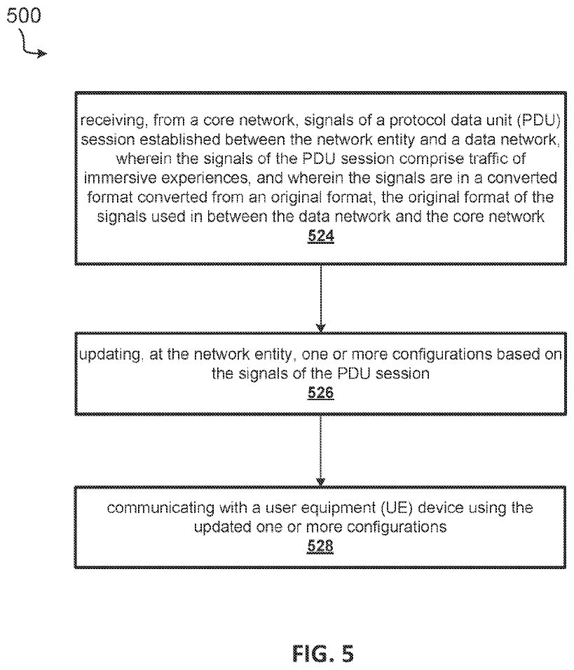

FIG. 5 is a flow diagram 500 depicting a method of wireless communications indicating traffic characteristics by a network entity, according to some embodiments. The method is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. The method of the flow diagram 500 is performed by a network entity, such as the RAN 112 of FIGS. 1-4. The network entity may include one or more radio frequency (RF) modems, a processor coupled to the one or more RF modems, and at least one non-transient memory storing executable instructions to manipulate at least one of the processor or the RF modems to perform the method of the flow diagram 500.

With reference to FIG. 5, method illustrates example functions used by various embodiments. Although specific function blocks (“blocks”) are disclosed in method, such blocks are examples. That is, embodiments are well suited to performing various other blocks or variations of the blocks recited in method. It is appreciated that the blocks in method may be performed in an order different than presented, and that not all of the blocks in method may be performed.

As shown in FIG. 5, the method includes the block 524 of receiving, from a core network, an indication of parameters of a protocol data unit (PDU) session established between the network entity and a data network (e.g., operation 324 of FIG. 3). The parameters are in a converted format converted from an original format. The data network sends to the core network parameters in the original format. For example, the network entity includes a RAN (e.g., the RAN 112) receiving service data units (SDUs) from one or more network functions of the core network. The one or more network functions may include an AF. The immersive experiences may include an XR application.

The SDUs received from the one or more network functions of the core network may include at least one of: a periodicity of a PDU set; a periodicity of a video frame or slice; a start time of a first PDU set, a first video frame, or a first video slice; an identifier (ID) of the first PDU set, the first video frame, or the first video slice; information about relationship of PDUs within the PDU set, the video frame, or the video slice; an indication of a last PDU in the PDU set; a priority associated with the PDU set, the video frame, or the video slice; a delay budget associated with the PDU set, the video frame, or the video slice; a size of the PDU set, the video frame, or the video slice; and jitter statistics of the traffic.

The method includes the block 526 of updating, at the network entity, one or more wireless signaling configurations based on the parameters of the PDU session (e.g., operation 326 of FIG. 3). The configurations may include scheduling configurations for periodic and deterministic traffic flows to be scheduled via one or more of: configured grants; semi-persistent grants; and dynamic grants.

The method includes the block 528 of communicating with a UE device using the updated one or more configurations (e.g., operation 328 of FIG. 3). For example, the updated one or more configurations may include at least one of: a connected mode discontinuous reception (C-DRX) cycle for data traffic of XR media based on a periodicity attribute of the TSCAI; a C-DRX start offset for the data traffic of XR media based on a burst arrival time attribute of the TSCAI; a C-DRX inactivity timer for the data traffic of XR media based on a frame duration attribute of the TSCAI; or a C-DRX enabled duration for the data traffic of XR media based on jitter or jitter statics attribute of the TSCAI.

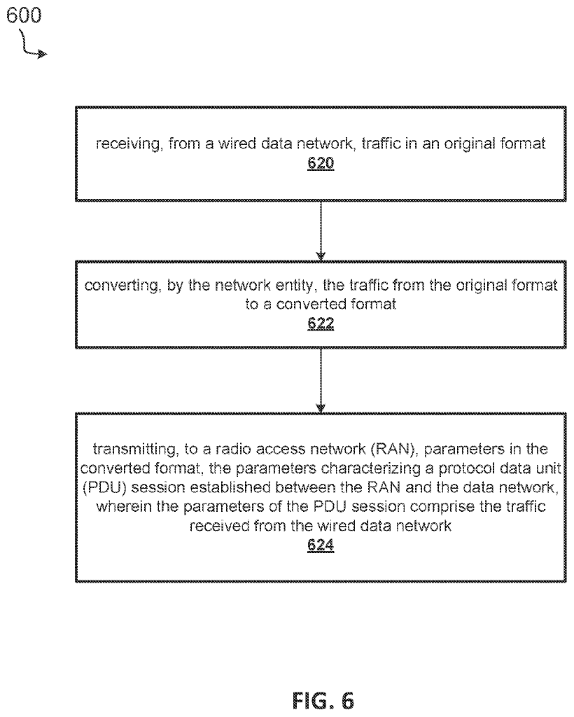

FIG. 6 is a flow diagram 600 depicting a method of wireless communications by a network entity, according to some embodiments. The method is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. The method of the flow diagram 600 is complementary to the method of the flow diagram 500 and is performed by a core network, such as the core network 150 of FIGS. 1-4. The core network may include one or more radio frequency (RF) modems, a processor coupled to the one or more RF modems, and at least one non-transient memory storing executable instructions to manipulate at least one of the processor or the RF modems to perform the method of the flow diagram 600.

As shown in FIG. 6, the method includes the block 620 of receiving, from a wired data network, traffic in an original format (e.g., operation 320 of FIG. 3). The method includes the block 622 of converting, by the network entity, the traffic from the original format to a converted format (e.g., operation 322 of FIG. 3). The method includes the block 624 of transmitting, to a RAN, parameters in the converted format, the parameters characterizing a PDU session established between the RAN and the data network (e.g., operation 324 of FIG. 3). The parameters of the PDU session may include the traffic received from the wired data network.

Referring to both methods of the flow diagrams 500 and 600, in some embodiments, the converted format includes one or more fields and values directly mapped from fields and values of the original format. The converted format includes one or more fields and values derived from the fields and values of the original format.

When the converted format includes time sensitive communication (TSC) assistance information (TSCAI) of a TSC service, the traffic is characterized by characteristics carried with attributes of the TSCAI. For example, the converted format may include at least one of the following fields: traffic type, XR traffic flow, encryption keys, group of pictures (GoP) information, synchronization information; or configuration granularity.

In some cases, the original format between the data network and the core network conforms to SDP and the attributes of the TSCAI are in a mapping relationship to attributes of the SDP. The mapping relationship may include (1) one-to-one, (2) multiple-to-one, and/or (3) one-to-multiple mapping between the attributes of the SDP and the attributes of the TSCAI.

In aspects, the parameters of the PDU session include one or a combination of two or more of the signals below. For example, the parameters include signals of a video frame or slice priority for the data traffic of XR media based on one of the attributes of the TSCAI. The parameters include signals of a number of PDUs in a PDU set for the data traffic of XR media based on one of the attributes of the TSCAI. The parameters include signals of statistics of PDU set sizes for the data traffic of XR media based on one of the attributes of the TSCAI, wherein the statistics of PDU set sizes includes at least values of: a median, a mean, a standard deviation, a maximum, and a minimum, measured in bits, bytes, or kilobytes.

The parameters may include signals of statistics of video frame or slice for the data traffic of XR media based on one of the attributes of the TSCAI, wherein the statistics of PDU set sizes includes at least values of: a median, a mean, a standard deviation, a maximum, and a minimum, measured in bits, bytes, or kilobytes. The parameters include signals of a delay budget based on one of the attributes of the TSCAI, wherein the delay budget includes one or more of budgets: per application, per traffic flow, per type of video frame, per type of video slice, or per PDU set. The parameters include signals of group of pictures (GoP) information based on one of the attributes of the TSCAI. The GoP information includes at least one of: size of a GoP, a start time of the GoP, a time offset of the GoP, or a type of video frames/slices in the GoP.

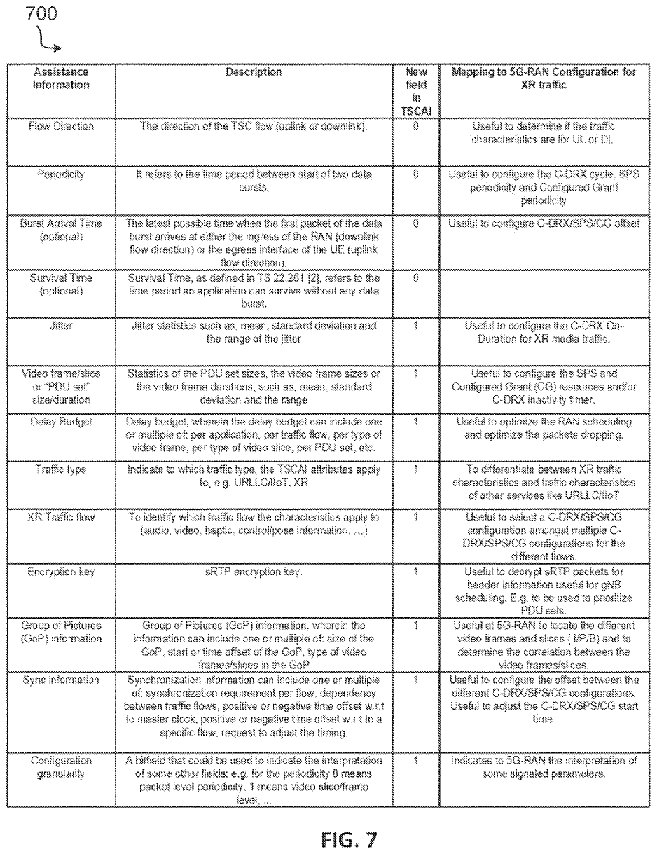

The parameters may include signals of synchronization information based on one of the attributes of the TSCAI, wherein the synchronization information includes one or more of: synchronization requirements per flow, dependency between traffic flows, a positive or negative time offset with respect to a master clock, a positive or negative time offset with respect to a specific flow, and a request to adjust the timing. Examples of the parameters of the attributes of the TSCAI are further illustrated in FIG. 7 and described below.

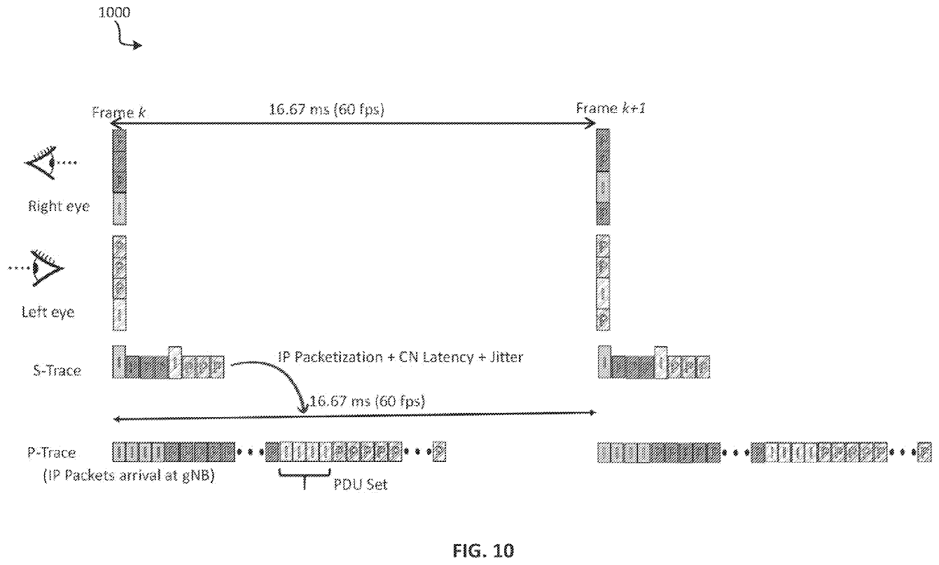

In aspects, the RAN may update one or more configurations by configuring a first set of characteristics of the traffic per quality of service (QOS) flow; or configuring a second set of characteristics of the traffic per a type of video frame or a type of video slice. The type of video frame may include at least one of I-frame, P-frame, or B-frame, and the type of video slides may include at least one of I-slice, P-slice, or B-slice. Video frame examples are briefly discussed in relation to FIG. 10.

In aspects, the wired data network configures the traffic based on a type of video frame and/or a type of video slice. The type of video frames may include at least one of: I-frame, P-frame, or B-frame. The type of video slices may include at least one of I-slice, P-slice, or B-slice. Examples of the video frames or slices are illustrated in FIG. 10 and further described below.

When the converted format includes NGAP, the indication of the parameters of the PDU session may include a message of a PDU session resource setup request; or a message of a PDU session resource modification request. For example, the indication of the parameters may include an information element (IE) in the messages. The IE may indicate one or a combination of two or more of: traffic periodicity, a packet time, a maximum packet time, a burst arrival time, a bandwidth, jitter statistics, an encryption key, a frame duration, a priority of video frame or slice, and a number of PDUs in a PDU set.

The IE may also indicate statistics of PDU set sizes. The statistics of PDU set sizes includes at least values of: a median, a mean, a standard deviation, a maximum, and a minimum, measured in bits, bytes, or kilobytes. The IE may also indicate statistics of video frame or slice including at least values of: a median, a mean, a standard deviation, a maximum, and a minimum, measured in bits, bytes, or kilobytes.

The IE may also indicate a delay budget including one or more of budgets: per application, per traffic flow, per type of video frame, per type of video slice, or per PDU set. The IE may also indicate group of pictures (GoP) information including at least one of: size of a GoP, a start time of the GoP, a time offset of the GoP, or a type of video frames/slices in the GoP. The IE may indicate synchronization information including one or more of: synchronization requirements per flow, dependency between traffic flows, a positive or negative time offset with respect to a master clock, a positive or negative time offset with respect to a specific flow, and a request to adjust the timing. The IE may also indicate a priority of a PDU set.

The PDU set may include at least one of an identifier (ID) of the PDU set; a label; a time stamp; a sequence number; a delay budget; a reliability requirement; a number of PDUs in the PDU set; a codec layer associated with the PDU set; information about essential PDUs; or a start and an end of the PDU set; a priority of the PDU set. The PDU set may also include an indication of whether the PDU set is associated with at least one of: an I-frame, P-frame, B-frame, I-slice, P-slice, or B-slice. The PDU set may include an indication of whether the PDU set is associated with at least one of: a field of view (FoV), a non-FoV, baseline layer, enhanced layer, virtual reality (VR) traffic, media traffic, or haptic traffic. The PDU set may include an indication of a correlation or dependency to other PDU sets.

In some cases, the PDU set is signaled in a field of a general packet radio service (GPRS) tunneling protocol (GTP) user-data (GTP-U) header, wherein the field is specific to the traffic of the immersive experiences. The PDU set may be signaled in a field of a PDU session container of the GTP-U header, wherein the field is specific to the traffic of the immersive experiences. In some cases, at least part of the PDU set is mapped from a differentiated service code points (DSCP) to the GTP-U header.

FIG. 7 illustrates an example table 700 mapping information from an application server to information (e.g., configuration) between RAN and UE devices, according to some embodiments. When the converted format is TSCAI, the core network 150 may signal the traffic specific information to the RAN 112 by mapping to existing attributes (e.g., “0” in the “New Field in TSCAI” column of FIG. 7) or adding new attributes (e.g., “1” in the “New Field in TSCAI” column of FIG. 7) to the TSCAI of the TSC flow. The table 700 lists TSCAI (“Assistance Information”) with intended mapping to 5G-RAN configuration for XR traffic (“Mapping to 5G-RAN Configuration for XR Traffic”).

The mapping may use SDP protocol, which is a format used by entities to agree on compatible media types and parameters for interactions like voice and video. A mapping of some SDP attributes to some TSC existing or new attributes may be used to signal the traffic characteristics to the RAN 112. For example, in existing fields, the TSCAI “Periodicity” attribute is mapped to the XR/Cloud-Gaming and/or media traffic periodicity, which may be useful to configure the C-DRX cycle, SPS periodicity and Configured Grant periodicity. To obtain the periodicity information, the SDP frame rate attribute (a=framerate:<frame rate>) may be mapped to the TSCAI “Periodicity.”

Sometimes conversions in addition to mapping may be needed. For example, in TSCAI, the periodicity is at the packet level, while for the XR traffic, the periodicity is at the “PDU set” and/or video slice/frame level. As a result, the RAN 112 may interpret the TSCAI “Periodicity” attribute differently depending on whether the TSCAI periodicity is used for XR and media service or for any other service (e.g. URLLC). To clarify this potential ambiguity, a new TSCAI attribute may be added, as shown in FIG. 7, to indicate the service or signal the different attribution(s). For example, a new attribute may signal if the periodicity is at the packet level or at the level of “PDU set” or video frame/slice. The interpretation of the “Periodicity” may depend on whether other attributes have been enabled (like the jitter attribute, or “PDU set” priority attribute) to provide a context to avoid different interpretations.

For example, a new TSCAI attribute may be specified to signal the video frame size or the video frame duration (e.g., in ms). This size/duration information may be useful for 5G RAN to configure for example the DRX Inactivity Timer.

During conversion, the TSCAI attribute may be mapped from the SDP packet time attribute. For example, a maximum packet time (e.g., a=maxptime:<maximum packet time>) may be used to indicate the maximum amount/duration of media that can be encapsulated in each packet, expressed as time in milliseconds. Packet Time a=ptime:<packet time>defined as the length of time in milliseconds represented by the media in a packet.

The TSCAI may indicate a start time of a specific flow to the RAN 112 to help improve the scheduling by configuring for example the C-DRX periodicity start offset. For example, the existing TSN attribute “Burst Arrival Time” may be used to indicate this information to the RAN 112. The TSN attribute “Burst Arrival Time” may be determined from the SDP attribute “t=<start time>,” which specifies the start time for a media session.

The TSCAI may indicate a bandwidth to the RAN 112 to help improve the scheduling by better planning the resource allocation. The RAN 112 may use the information of the bandwidth that the application is planning to allocate for the service/flow to decide and report on whether the RAN 112 can meet the required bandwidth. A new TSCAI attribute (e.g. Bandwidth) may be used as shown in table 700 to signal the bandwidth to the 5G RAN. The TSCAI attribute may be derived from the SDP attribute “Bandwidth,” which specifies the bandwidth to be used by the session or the media. The unit of the bandwidth may be Kbps or Mbps.

The TSCAI may indicate jitter statistics, which are estimated at the codec level or at the 5G AF 163/173 and signalled to the RAN 112. As shown in table 700, new TSC attributes (e.g., Jitter mean, STD, maximum, minimum) may be added to signal the jitter statistics to the RAN 112. The core network 150 may use an algorithm to estimate the jitter and derive the jitter statistics at the 5G AF 163/173 or at the codec level (using filtering/averaging methods). The jitter statistics may be signaled per media flow (audio, video, etc.) or/and per video frame/slice type.

The TSCAI may indicate an encryption key, as shown in table 7. If transported over a secure and trusted path, the encryption key to the RAN 112 for deep packet inspection for information that may be encrypted at the codec or the application level. The RAN 112 may use the encryption key to retrieve information that may be useful to optimize the scheduling and the QoE. For example, the TSCAI encryption key attribute may be derived from the SDP attribute “Encryption Key” that specifies the encryption key that is used for all media in the sessions.

The table 700 provides description and mapping of various TSCAI fields or entries not exhaustively discussed herein. The table 700 may further include other fields not illustrated or enumerated. Someone having ordinary skills in the art may use the information in the table 700 and add additional fields of similar nature (e.g., for characterizing aspects of specific traffic from the data network) to implement the example conversions provided herein. Although the table 700 uses 5G RAN and XR traffic as examples, the mapping or conversion techniques may be applicable to other wireless communication systems and other traffic types.

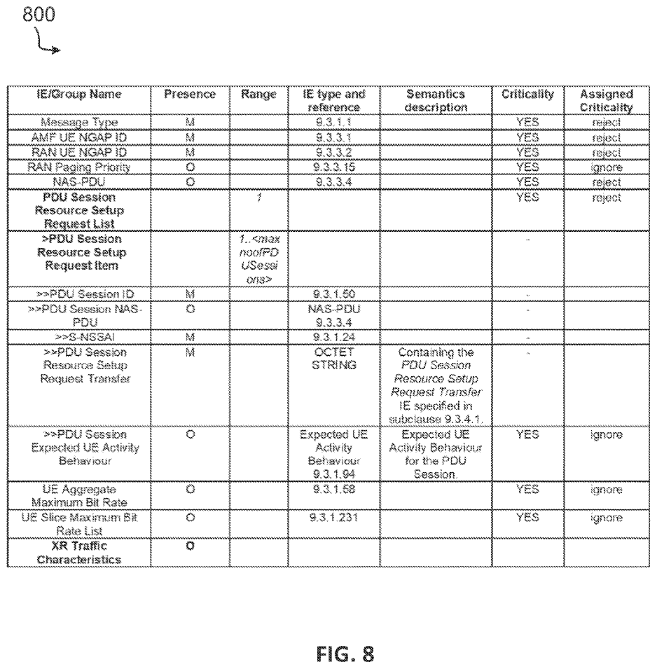

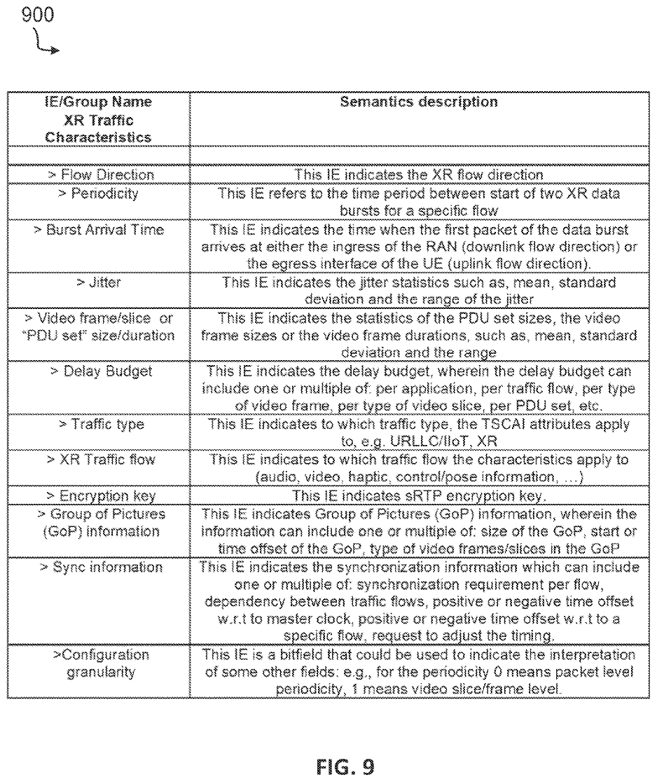

FIG. 8 illustrates an example table 800 of information elements in a protocol data unit (PDU) session resource setup request, according to some embodiments. As discussed above, the converted format may include NGAP messages. New information elements (IEs) may be included in NGAP messages (e.g., PDU Session Resource Setup Request or PDU Session Resource Modify Request message) to describe traffic characteristics, as shown in the table 800 (as well as the table 900 of FIG. 9). For NGAP, the “PDU Session Resource Setup Request” may be used. The AMF (e.g., the AMF 422) may send the PDU Session Resource Setup Request to request the RAN 112 to assign resources on Uu and NG-U for one or several PDU session resources (e.g., the PDU session 157). The “PDU Session Resource Modify Request message” may also be used. For example, the AMF 422 may send this message to request the RAN 112 to enable modifications of already established PDU session resources for a given UE device 105. As shown in table 800, PDU session resource setup request list and item may indicate the traffic characteristics. Furthermore, the table 800 may include a new “XR Traffic Characteristics” field for further XR traffic indication. Corresponding examples of IEs are discussed in FIG. 9.

FIG. 9 illustrates an example table 900 of IEs of traffic characteristics, according to some embodiments. As shown in the table 900, an example IE or IE group may be defined/specified to the “PDU Session Resource Setup Request” and/or “PDU Session Resource Modify Request message.” The example IE may be added to specifically signal the traffic periodicity. Alternatively, the “Periodicity” may be part of the Information Element identifying some traffic characteristics.

An example IE or IE group may be defined/specified to the “PDU Session Resource Setup Request” and/or “PDU Session Resource Modify Request Message.” The example IE may be added to specifically signal the “packet time” or the “maximum packet time.” Alternatively, the “packet time” or the “maximum packet time” may be part of the IE identifying some traffic characteristics. An example IE or IE group may be defined/specified to the “PDU Session Resource Setup Request” and/or “PDU Session Resource Modify Request message.” The example IE may be added to specifically signal the “Burst Arrival Time.” Alternatively, the “Burst Arrival Time” may be part of the Information Element identifying some traffic characteristics.

An example IE or IE group may be defined/specified to the “PDU Session Resource Setup Request” and/or “PDU Session Resource Modify Request message.” The example IE may be added to specifically signal the “Bandwidth.” Alternatively, the “Bandwidth” may be part of the Information Element identifying some traffic characteristics. An example IE or IE group may be defined/specified to the “PDU Session Resource Setup Request” and/or “PDU Session Resource Modify Request message.” The example IE may be added to specifically signal the “Jitter statistics.” Alternatively, the “Jitter statistics” may be part of the Information Element identifying some traffic characteristics.

An example IE or IE group may be defined/specified to the “PDU Session Resource Setup Request” and/or “PDU Session Resource Modify Request message.” The example IE may be added to specifically signal the “Encryption key.” Alternatively, the “Encryption key” may be part of the Information Element identifying some traffic characteristics.

The table 900 may include a field of a general packet radio service (GPRS) tunneling protocol (GTP) user-data (GTP-U) header. The field may be specific to the traffic of the immersive experiences. The PDU set may be signaled in a field of a PDU session container of the GTP-U header, wherein the field is specific to the traffic of the immersive experiences. In some cases, at least part of the PDU set is mapped from a differentiated service code points (DSCP) to the GTP-U header. The UPF of the 5G core network uses the GTP-U header to transmit the data to the RAN. A PDU session container is included in the GTP-U header to identify the QoS flow. GTP-U header can be used to carry information about the “PDU set.”

FIG. 10 illustrates an example 1000 of video frames fragmentation and data packetization into PDU sets, according to some embodiments. The example 1000 provides an example IP packetization into a PDU set with core network latency information, and jitter information. The illustration of the IP packetization is in the context of gradual decoding refresh (GDR) but can also apply to the instantaneous decoder refresh (IDR). GDR allows random access and stable data rate, hence more suitable for network transmission. In the illustration, the video frame of the right eye and the video frame of the left eye are aggregated in a single video frame. The video frame for the left eye and the video frame for the right eye could be staggered or aligned. In the GDR model, one video frame is constituted of multiple video slices (e.g. 4 slices, 8 slices, . . . ). One of the slices is an I-slice to refresh the image and the remaining slices are P-slices. Transformation from video trace (V-trace) to slice trace (S-trace) consists of concatenating the video slices. Transformation from the Slice trace (S-trace) to Packet trace (P-trace) consists of packetization (e.g. based on the Ethernet maximum transmission unit (MTU)). A PDU set in the illustration consists of a group of PDUs sharing the same QoS requirements.

GDR is used in ultra-low latency applications, such as XR traffic. During operation, if a decoder starts decoding at the middle of a coded stream and follows the signaling above, the decoder may obtain a reconstructed frame that is completely updated when the indicated gradual decoder refresh conditions are fulfilled. For example, p-frames (e.g., changes from the reference i-frame, which represents a complete image) may reconstruct a frame with low latency. As shown in the example 1000, packets may be streamed in the sequence of p-frames and i-frames for each eye (e.g., for a VR headset as the UE device 105). By comparison, IDR is a header that the encoder writes to the data stream to send a signal to the decoder to reset the references.

During operation, reference frames are stored in the buffer for restoring frames that follow (e.g., by including changes from the reference frames). When IDR is received, however, the decoder may reset the reference frames and start the decoding process without references. This happens when the reference frames are no longer needed for further decoding (e.g., when the user rewinds the video stream to another timestamp). For example, the decoder seeks the beginning of the GOP, decodes the i-frame and resets the old reference frames. When IDR is present, the decoder may fill the buffer with new reference frames. An IDR may be placed on an i-frame. Not all i-frame includes an IDR. As such, the i-frames and the p-frames have drastically different sizes in transmission, causing volume fluctuations. In GDR, the fluctuation is tamed by having an i-frame in each of the transmission slice (e.g., one i-frame with multiple p-frames).

As shown in the example 1000, a PDU set may include packets from the slices of each eye from multiple frames. As discussed above, the converted format indicating parameters of the traffic characteristics (e.g., specific to XR traffic) may indicate PDU and PDU set information (e.g., relationship, priority, budget, dropping, etc.). Although the PDU set may take on other contents or format, the example 1000 provides an example implementation of a PDU set.

Unless specifically stated otherwise, terms such as “establishing,” “receiving,” “transmitting,” or the like, refer to actions and processes performed or implemented by computing devices that manipulates data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

### EXAMPLE ASPECTS

Example 1 is a method of wireless communications by a network entity, the method comprising:
receiving, from a core network, an indication of parameters of a protocol data unit (PDU) session established between the network entity and a data network, wherein the parameters are in a converted format converted from an original format, the original format of the parameters used for traffic in between the data network and the core network;
updating, at the network entity, one or more wireless signaling configurations based on the parameters of the PDU session; and
communicating with a user equipment (UE) device using the updated one or more configurations.

Example 2 is a method according to example 1, wherein the one or more configurations comprise scheduling configurations for traffic flows to be scheduled via one or more of:
configured grants;
semi-persistent grants; and
dynamic grants for downlink or uplink transmissions.

Example 3 is a method according to example 1, wherein:
the network entity comprises a radio access network (RAN) receiving service data units (SDUs) from one or more network functions of the core network, wherein the one or more network functions comprise an application function (AF);
the immersive experiences comprise an application of extended reality (XR); or
the original format between the data network and the core network comprises session description protocol (SDP).

Example 4 is a method according to any of examples 1 to 3, wherein the data network comprises an XR server or wherein the data network provides, to the core network, a data stream encoded by a video codec.

Example 5 is a method according to any of examples 1 to 4, wherein the SDUs comprise one or a combination of two or more of:
a periodicity of a PDU set;
a periodicity of a video frame or slice;
a start time of a first PDU set, a first video frame, or a first video slice;
an identifier (ID) of the first PDU set, the first video frame, or the first video slice;
information about relationship of PDUs within the PDU set, the video frame, or the video slice;
an indication of a last PDU in the PDU set;
a priority associated with the PDU set, the video frame, or the video slice;
a delay budget associated with the PDU set, the video frame, or the video slice;
a size of the PDU set, the video frame, or the video slice; and
jitter statistics of the traffic.

Example 6 is a method according to example 1 or 3, wherein the converted format comprises one or more fields and values directly mapped from fields and values of the original format.

Example 7 is a method according to example 1 or 3, wherein the converted format comprises one or more fields and values derived from the fields and values of the original format.

Example 8 is a method according to example 6 or 7, wherein the converted format comprises time sensitive communication (TSC) assistance information (TSCAI) of a TSC service, and wherein the traffic is characterized by characteristics carried with attributes of the TSCAI.

Example 9 is a method according to example 8, wherein the converted format comprises one or a combination of two or more of the following fields:
traffic type;
XR traffic flow;
encryption keys;
group of pictures (GoP) information;
synchronization information; and
configuration granularity.

Example 10 is a method according to example 8, wherein the original format between the data network and the core network conforms to session description protocol (SDP) and the attributes of the TSCAI are in a mapping relationship to attributes of the SDP.

Example 11 is a method according to example 10, wherein the mapping relationship comprises (1) one-to-one, (2) multiple-to-one, and (3) one-to-multiple mapping between the attributes of the SDP and the attributes of the TSCAI.

Example 12 is a method according to example 1, wherein the traffic is configured based on a type of video frames or a type of video slices, wherein the type of video frames comprises at least one of: I-frame, P-frame, or B-frame, and wherein the type of video slices comprises at least one of I-slice, P-slice, or B-slice.

Example 13 is a method according to example 8, wherein updating, at the network entity, the one or more configurations comprise one or a combination of two or more of:
configuring a connected mode discontinuous reception (C-DRX) cycle for data traffic of XR media based on a periodicity attribute of the TSCAI;
configuring a C-DRX start offset for the data traffic of XR media based on a burst arrival time attribute of the TSCAI;
configuring a C-DRX inactivity timer for the data traffic of XR media based on a frame duration attribute of the TSCAI; and
configuring a C-DRX enabled duration for the data traffic of XR media based on jitter or jitter statics attribute of the TSCAI;

Example 14 is a method according to example 8, wherein the parameters of the PDU session comprise one or a combination of two or more of:
signals of a video frame or slice priority for the data traffic of XR media based on one of the attributes of the TSCAI;
signals of a number of PDUs in a PDU set for the data traffic of XR media based on one of the attributes of the TSCAI;
signals of statistics of PDU set sizes for the data traffic of XR media based on one of the attributes of the TSCAI, wherein the statistics of PDU set sizes comprises at least values of: a median, a mean, a standard deviation, a maximum, and a minimum, measured in bits, bytes, or kilobytes;
signals of statistics of video frame or slice for the data traffic of XR media based on one of the attributes of the TSCAI, wherein the statistics of PDU set sizes comprises at least values of: a median, a mean, a standard deviation, a maximum, and a minimum, measured in bits, bytes, or kilobytes;
signals of a delay budget based on one of the attributes of the TSCAI, wherein the delay budget comprises one or more of budgets: per application, per traffic flow, per type of video frame, per type of video slice, or per PDU set;
signals of group of pictures (GoP) information based on one of the attributes of the TSCAI, wherein the GoP information comprises at least one of: size of a GoP, a start time of the GoP, a time offset of the GoP, or a type of video frames/slices in the GoP; and
signals of synchronization information based on one of the attributes of the TSCAI, wherein the synchronization information comprises one or more of: synchronization requirements per flow, dependency between traffic flows, a positive or negative time offset with respect to a master clock, a positive or negative time offset with respect to a specific flow, and a request to adjust the timing.

Example 15 is a method according to example 1, wherein updating, at the network entity, the one or more configurations comprises at least one of:
configuring a first set of characteristics of the traffic per quality of service (QOS) flow; or
configuring a second set of characteristics of the traffic per a type of video frame or a type of video slice, wherein the type of video frame comprises at least one of I-frame, P-frame, or B-frame, and the type of video slides comprises at least one of I-slice, P-slice, or B-slice.

Example 16 is a method according to example 6 or 7, wherein the converted format comprises new generation application protocol (NGAP).

Example 17 is a method according to example 16, wherein the indication of the parameters of the PDU session comprise at least one of:
a message of a PDU session resource setup request; or
a message of a PDU session resource modification request.

Example 18 is a method according to example 17, wherein the indication of the parameters of the PDU session comprise an information element (IE) of the message of the PDU session resource setup request or the message of the PDU session resource modification request, the IE indicating one or a combination of two or more of:
traffic periodicity;
a packet time;
a maximum packet time;
a burst arrival time;
a bandwidth;
jitter statistics;
an encryption key;
a frame duration;
a priority of video frame or slice;
a number of PDUs in a PDU set;
statistics of PDU set sizes, wherein the statistics of PDU set sizes comprises at least values of: a median, a mean, a standard deviation, a maximum, and a minimum, measured in bits, bytes, or kilobytes;
statistics of video frame or slice comprising at least values of: a median, a mean, a standard deviation, a maximum, and a minimum, measured in bits, bytes, or kilobytes;
a delay budget comprising one or more of budgets: per application, per traffic flow, per type of video frame, per type of video slice, or per PDU set;
group of pictures (GoP) information comprising at least one of: size of a GoP, a start time of the GoP, a time offset of the GoP, or a type of video frames/slices in the GoP;
synchronization information comprising one or more of: synchronization requirements per flow, dependency between traffic flows, a positive or negative time offset with respect to a master clock, a positive or negative time offset with respect to a specific flow, and a request to adjust the timing; and
a priority of a PDU set.

Example 19 is a method according to example 5, wherein the PDU set comprises one or a combination of two or more of:
an ID of the PDU set;
a label;
a time stamp;
a sequence number;
a delay budget;
a reliability requirement;
a number of PDUs in the PDU set;
a codec layer associated with the PDU set;
information about essential PDUs;
a start and an end of the PDU set;
a priority of the PDU set;
an indication of whether the PDU set is associated with at least one of: an I-frame, P-frame, B-frame, I-slice, P-slice, or B-slice;
an indication of whether the PDU set is associated with at least one of: a field of view (FoV), a non-FoV, baseline layer, enhanced layer, virtual reality (VR) traffic, media traffic, or haptic traffic; and
a correlation or dependency to other PDU sets.

Example 20 is a method according to example 19, wherein the PDU set is signaled in a field of a general packet radio service (GPRS) tunneling protocol (GTP) user-data (GTP-U) header, wherein the field is specific to the traffic of immersive experiences.

Example 21 is a method according to example 20, wherein the PDU set is signaled in a field of a PDU session container of the GTP-U header, wherein the field is specific to the traffic of the immersive experiences.

Example 22 is a method according to example 20, wherein at least part of the PDU set is mapped from a differentiated service code points (DSCP) to the GTP-U header.

Example 23 is a method of wireless communications by a network entity, the method comprising:
receiving, from a wired data network, traffic in an original format;
converting, by the network entity, the traffic from the original format to a converted format, wherein the converted format characterizes video related properties of the traffic; and
transmitting, to a radio access network (RAN), parameters in the converted format, the parameters characterizing a protocol data unit (PDU) session established between the RAN and the data network, wherein the parameters of the PDU session comprise the traffic received from the wired data network.

Example 24 is a method according to example 23, wherein the network entity comprises a core network transmitting service data units (SDUs) to the RAN, the core network comprising one or more network functions having at least one application function (AF); and
wherein the traffic comprises traffic of immersive experiences of an application of extended reality (XR).

Example 25 is a method according to example 23, wherein the original format between the data network and the network entity comprises session description protocol (SDP).

Example 26 is a method according to any of examples 23 to 25, wherein the data network comprises an XR server or wherein the data network provides, to the network entity, a data stream encoded by a video codec.

Example 27 is a method according to any of examples 23 to 26, wherein the SDUs comprise one or a combination of two or more of:
a periodicity of a PDU set;
a periodicity of a video frame or slice;
a start time of a first PDU set, a first video frame, or a first video slice;
an identifier (ID) of the first PDU set, the first video frame, or the first video slice;
information about relationship of PDUs within the PDU set, the video frame, or the video slice;
an indication of a last PDU in the PDU set;
a priority associated with the PDU set, the video frame, or the video slice;
a delay budget associated with the PDU set, the video frame, or the video slice;
a size of the PDU set, the video frame, or the video slice; and
jitter statistics of the traffic.

Example 28 is a method according to example 23 or 25, wherein the converted format comprises one or more fields and values directly mapped from fields and values of the original format.

Example 29 is a method according to example 23 or 25, wherein the converted format comprises one or more fields and values derived from the fields and values of the original format.

Example 30 is a method according to example 28 or 29, wherein the converted format comprises time sensitive communication (TSC) assistance information (TSCAI) of a TSC service, and wherein the traffic is characterized by characteristics carried with attributes of the TSCAI.

Example 31 is a method according to example 30, wherein the converted format comprises one or a combination of two or more of the following fields:
traffic type;
XR traffic flow;
encryption keys;
group of pictures (GoP) information;
synchronization information; and
configuration granularity.

Example 32 is a method according to example 30, wherein the original format between the data network and the core network conforms to session description protocol (SDP) and the attributes of the TSCAI are in a mapping relationship to attributes of the SDP.

Example 33 is a method according to example 32, wherein the mapping relationship comprises (1) one-to-one, (2) multiple-to-one, and (3) one-to-multiple mapping between the attributes of the SDP and the attributes of the TSCAI.

Example 34 is a method according to example 23, wherein the traffic is configured based on a type of video frames or a type of video slices, wherein the type of video frames comprises at least one of: I-frame, P-frame, or B-frame, and wherein the type of video slices comprises at least one of I-slice, P-slice, or B-slice.

Example 35 is a network entity comprising:
one or more radio frequency (RF) modems;
a processor coupled to the one or more RF modems; and
at least one memory storing executable instructions, the executable instructions to manipulate at least one of the processor or the one or more RF modems to perform the method of any of examples 1-22.

Example 36 is a network entity comprising:
one or more radio frequency (RF) modems;
a processor coupled to the one or more RF modems; and
at least one memory storing executable instructions, the executable instructions to manipulate at least one of the processor or the one or more RF modems to perform the method of any of examples 23-34.

1-18. (canceled)

19. A method of wireless communications by a network entity, the method comprising:
receiving, from a core network, an indication of parameters of a protocol data unit (PDU) session established between the network entity and a data network, wherein the parameters are in a converted format converted from an original format, the original format of the parameters used for traffic in between the data network and the core network, and wherein the converted format comprises time sensitive communication (TSC) assistance information (TSCAI);
updating, at the network entity, a wireless signaling configuration based on the parameters of the PDU session; and
communicating with a user equipment (UE) using the updated wireless signaling configuration.

20. The method of claim 1, wherein the wireless signaling configuration comprises scheduling configurations for traffic flows to be scheduled via at least one of:
configured grants;
semi-persistent grants; or
dynamic grants for downlink or uplink transmissions.

21. The method of claim 1, wherein:
the network entity comprises a radio access network (RAN) receiving service data units (SDUs) from a network function of the core network, wherein:
the network function comprises an application function (AF);
the traffic comprises an application of extended reality (XR); or
the original format between the data network and the core network comprises session description protocol (SDP).

22. The method of claim 1, wherein the data network comprises an extended reality (XR) server or wherein the data network provides, to the core network, a data stream encoded by a video codec.

23. The method of claim 3, wherein the SDUs comprise at least one of:
a periodicity of a PDU set, wherein the PDU set is signaled in a field of a general packet radio service (GPRS) tunneling protocol (GTP) user-data (GTP-U) header;
a periodicity of a video frame or slice;
a start time of a first PDU set, a first video frame, or a first video slice;
an identifier (ID) of the first PDU set, the first video frame, or the first video slice;
information about relationship of PDUs within the PDU set, the video frame, or the video slice;
an indication of a last PDU in the PDU set;
a priority associated with the PDU set, the video frame, or the video slice;
a delay budget associated with the PDU set, the video frame, or the video slice;
a size of the PDU set, the video frame, or the video slice; or
jitter statistics of the traffic.

24. The method of claim 1, wherein the converted format comprises one or more fields and values directly mapped from fields and values of the original format.

25. The method of claim 1, wherein the converted format comprises one or more fields and values derived from the fields and values of the original format.

26. The method of claim 6, wherein:
the TSCAI comprises a parameter associated with jitter; and
the traffic is characterized by characteristics carried with attributes of the TSCAI, and wherein the converted format comprises one or a combination of two or more of the following fields:
traffic type;
XR traffic flow;
encryption keys;
group of pictures (GoP) information;
synchronization information; and
configuration granularity.

27. The method of claim 1, wherein the traffic is configured based on a type of video frames or a type of video slices, wherein the type of video frames comprises at least one of: I-frame, P-frame, or B-frame, and wherein the type of video slices comprises at least one of I-slice, P-slice, or B-slice.

28. The method of claim 1, wherein updating, at the network entity, the wireless signaling configuration comprises at least one of:
configuring a first set of characteristics of the traffic per quality of service (QOS) flow; or
configuring a second set of characteristics of the traffic per a type of video frame or a type of video slice, wherein the type of video frame comprises at least one of I-frame, P-frame, or B-frame, and the type of video slides comprises at least one of I-slice, P-slice, or B-slice.

29. The method of claim 6, wherein the converted format comprises new generation application protocol (NGAP), and wherein the indication of the parameters of the PDU session comprise at least one of:
a message of a PDU session resource setup request; or
a message of a PDU session resource modification request.

30. The method of claim 11, wherein the indication of the parameters of the PDU session comprise an information element (IE) of the message of the PDU session resource setup request or the message of the PDU session resource modification request, the IE indicating one or a combination of two or more of:
traffic periodicity;
a packet time;
a maximum packet time;
a burst arrival time;
a bandwidth;
jitter statistics;
an encryption key;
a frame duration;
a priority of video frame or slice;
a number of PDUs in a PDU set;
statistics of PDU set sizes, wherein the statistics of PDU set sizes comprises at least values of: a median, a mean, a standard deviation, a maximum, and a minimum, measured in bits, bytes, or kilobytes;
statistics of video frame or slice comprising at least values of: a median, a mean, a standard deviation, a maximum, and a minimum, measured in bits, bytes, or kilobytes;
a delay budget comprising one or more of budgets: per application, per traffic flow, per type of video frame, per type of video slice, or per PDU set;
group of pictures (GoP) information comprising at least one of: size of a GoP, a start time of the GoP, a time offset of the GoP, or a type of video frames/slices in the GoP;
synchronization information comprising one or more of: synchronization requirements per flow, dependency between traffic flows, a positive or negative time offset with respect to a master clock, a positive or negative time offset with respect to a specific flow, or a request to adjust the timing; and
a priority of a PDU set.

31. A method of communications by a core network entity, the method comprising:
receiving, from a data network, traffic in an original format;
converting, by the core network entity, parameters used for the traffic from the original format to a converted format, wherein the converted format characterizes video related properties of the traffic, and wherein the converted format comprises time sensitive communication (TSC) assistance information (TSCAI); and
transmitting, to a radio access network (RAN), the parameters in the converted format.

32. The method of claim 13, wherein:
the parameters characterize a protocol data unit (PDU) session established between the RAN and the data network and the traffic received from the data network;
the TSCAI comprises a parameter associated with jitter;
the core network entity includes at least one application function (AF) and transmits service data units (SDUs) to the RAN; or
wherein the traffic comprises traffic of an application of extended reality (XR).

33. The method of claim 14, wherein the SDUs comprise at least one of:
a periodicity of a PDU set;
a periodicity of a video frame or slice;
a start time of a first PDU set, a first video frame, or a first video slice;
an identifier (ID) of the first PDU set, the first video frame, or the first video slice;
information about relationship of PDUs within the PDU set, the video frame, or the video slice;
an indication of a last PDU in the PDU set;
a priority associated with the PDU set, the video frame, or the video slice;
a delay budget associated with the PDU set, the video frame, or the video slice;
a size of the PDU set, the video frame, or the video slice; or
jitter statistics of the traffic.

34. The method of claim 13, wherein the original format between the data network and the network entity comprises session description protocol (SDP).

35. The method of claim 13, wherein the traffic is configured based on a type of video frames or a type of video slices, wherein the type of video frames comprises at least one of: I-frame, P-frame, or B-frame, and wherein the type of video slices comprises at least one of I-slice, P-slice, or B-slice.

36. A network entity comprising:
one or more radio frequency (RF) modems;
a processor coupled to the one or more RF modems; and
at least one memory storing executable instructions, the executable instructions to manipulate at least one of the processor or the one or more RF modems to:
receive, from a core network, an indication of parameters of a protocol data unit (PDU) session established between the network entity and a data network, wherein the parameters are in a converted format converted from an original format, the original format of the parameters used for traffic in between the data network and the core network, and wherein the converted format comprises time sensitive communication (TSC) assistance information (TSCAI) ;
update, at the network entity, a wireless signaling configuration based on the parameters of the PDU session; and
communicate with a user equipment (UE) device using the updated wireless signaling configuration.

37. The network entity of claim 18, wherein the converted format comprises one or more fields and values derived from the fields and values of the original format.

38. The network entity of claim 19, wherein:
the TSCAI comprises a parameter associated with jitter; and
the traffic is characterized by characteristics carried with attributes of the TSCAI, and wherein the converted format comprises one or a combination of two or more of the following fields:
traffic type;
XR traffic flow;
encryption keys;
group of pictures (GoP) information;
synchronization information; and
configuration granularity.
